(19) United States
(12) Patent Application Publication
(10) Pub. No.: US 2017/0300453 A1
(43) Pub. Date: Oct. 19, 2017

(54) SYSTEM AND METHOD OF PROVIDING NOTIFICATION OF SUSPICIOUS ACCESS ATTEMPTS

(71) Applicants: HongHai Shen, Los Altos Hills, CA (US); Jing Li, Mountain View, CA (US)

(72) Inventors: HongHai Shen, Los Altos Hills, CA (US); Jing Li, Mountain View, CA (US)

(73) Assignee: GOOGLE INC., Mountain View, CA (US)

(21) Appl. No.: 12/483,491

(22) Filed: Jun. 12, 2009

(51) Int. Cl. G06F 15/16; G06F 3/048; H04L 9/32

(52) U.S. Cl. CPC G06F 15/16; H04L 9/32; G06F 3/048

(57) ABSTRACT

A system and method of preventing access to user information on a network is provided. In one aspect, if a request for information from one node is suspicious, the server may provide a notification to the user when the user logs in from another node. The notification may indicate the geographic location of the suspicious request.

### BACKGROUND OF THE INVENTION

As the use of online accounts for shopping and email has increased, so have the number of attacks on these accounts. Computer hijackers currently use various methods to obtain usernames, passwords, and personal information to login to online accounts. Unauthorized logins may result in misuse of accounts such as sending out spam emails or the loss of personal information such as credit card or other valuable information.

Malware and phishing sites gather private account information and use the information to access the accounts without authorization. For example, malware may use a key logger or packet sniffer to record usernames and passwords. In another example, a user may unknowingly send a phishing site disguised as a legitimate website, the user's username and password. The malware or phishing site may send this information to third parties, which may use the information to log into accounts and steal information.

Where a user's account has been compromised, it is difficult to restore the user's privacy. For example, malware removal tools such as anti-virus software may remove the malware but cannot prevent further unauthorized access to a compromised account. Currently, users must close accounts or change passwords to prevent further unauthorized access.

To identify fraudulent transactions, some systems determine whether the origination of attempts to access a user's account changes over time. In particular, credit card companies may flag transactions as suspicious based on a sudden change in location. For example, if a credit card number for an individual is used in New York and subsequently used in California or overseas, the credit card company may flag the transaction as suspicious and require further information.

Online systems may restrict access to information or user accounts based on changes in the type of browser. For example, if a user ordinarily logs into an account using Internet Explorer and subsequently uses the browser Mozilla, the system may restrict access to the account.

Although not preventing access to user information, some systems examine the network location of a user accessing an account and display this information to the user. For example, email systems, such as Gmail by Google, store a history of a user's recent IP addresses collected each time the user accesses the account. The system may determine the IP addresses of a computer attempting to access an account during the connection process through http protocols. Once a user accesses his account, Gmail allows the user to review the location of the last few logins.

It is also possible to approximate the geographic location of a request for information by examining the IP address associated with the request. Companies such as ip2location.com automatically determine and display a geographic location in response to receiving an IP address.

### BRIEF SUMMARY OF THE INVENTION

One aspect of the invention provides a method of preventing access to user information on a network. The method includes receiving a history log associated with user information, the user information being accessible via a first node on a network, where the user information comprises information associated with a user, and where a history log identifies a plurality of nodes of the network that accessed the user information; determining, with a processor, whether a node identified by the history log matches criteria associated with access that was not authorized by the user; transmitting to another node on the network, for display to the user, a geographic location for each of a plurality of the nodes identified by the history log; receiving, in response to the transmission, data identifying one of the nodes of the history log; and preventing the user information from being accessed by the identified node.

Another aspect of the invention relates to system with a memory storing instructions and a processor in communication with the memory so as to process information in accordance with the instructions. The instructions include transmitting, for display to a user, a history log associated with user information, where the user information comprises information associated with a user, and where a history log identifies a plurality of nodes of the network that accessed the user information; transmitting, for display to the user, a geographic location and a login time for each of the plurality of the nodes identified by the history log; receiving, in response to the transmission, data identifying one of the nodes of the history log; and preventing the user information from being accessed by the identified node.

A further aspect of the invention relates to system of preventing access to user information on a network. The system includes: a first computer at a first node of the network, the first computer comprising a memory storing a set of instructions and a processor that processes data in accordance with the first set of instructions and a plurality of second computers each at a different node of a network, each second computer capable of transmitting a request for information to the first computer. The set of instructions include determining whether a received request for information is suspicious, transmitting to one of the plurality of second computers a history log associated with user information, where the user information comprises information associated with a user, and where a history log identifies a plurality of the plurality of second computers that accessed the user information, transmitting, to the one of the plurality of second computers for display to a user, a geographic location associated with each of the identified computers of the history log, receiving from the one of the plurality of second computers information identifying one of the computers of the history log, and preventing the user information from being accessed by the identified computer.

### BRIEF DESCRIPTION OF THE DRAWINGS

FIG. 1 is a functional diagram of a system in accordance with an aspect of the invention.

FIG. 2 is a pictorial diagram of a system in accordance with an aspect of the invention.

FIG. 3 a functional diagram of a system in accordance with an aspect of the invention.

FIG. 4 is a functional diagram of a system in accordance with an aspect of the invention.

FIG. 5 is a functional diagram of a system in accordance with an aspect of the invention.

FIG. 6 is a functional diagram of a system in accordance with an aspect of the invention.

FIG. 7 is a functional diagram of a system in accordance with an aspect of the invention.

FIG. 8 is a functional diagram of a system in accordance with an aspect of the invention.

FIG. 9 is a functional diagram of a system in accordance with an aspect of the invention.

FIG. 10 is a functional diagram of a system in accordance with an aspect of the invention.

FIG. 11 is a functional diagram of a system in accordance with an aspect of the invention.

FIG. 12 is a screen shot in accordance with an aspect of the invention.

FIG. 13 is a screen shot in accordance with an aspect of the invention.

FIG. 14 is a functional diagram of a system in accordance with an aspect of the invention.

FIG. 15 is a functional diagram of a system in accordance with an aspect of the invention.

FIG. 16 is a functional diagram of a system in accordance with an aspect of the invention.

FIG. 17 is a screen shot in accordance with an aspect of the invention.

FIGS. 18a and 18b are a flowchart in accordance with an aspect of the invention.

### DETAILED DESCRIPTION

In one aspect, the system and method involve preventing unauthorized access to user information on a network. The method includes recording access time and network location for each login to access the information and determining whether a login is suspicious. Where the system identifies a suspicious login, upon the next non-suspicious login attempt, the user is prompted to identify which locations, based on network address and geographic location, may and may not access the information. Subsequent requests for information originating from a restricted location may be denied.

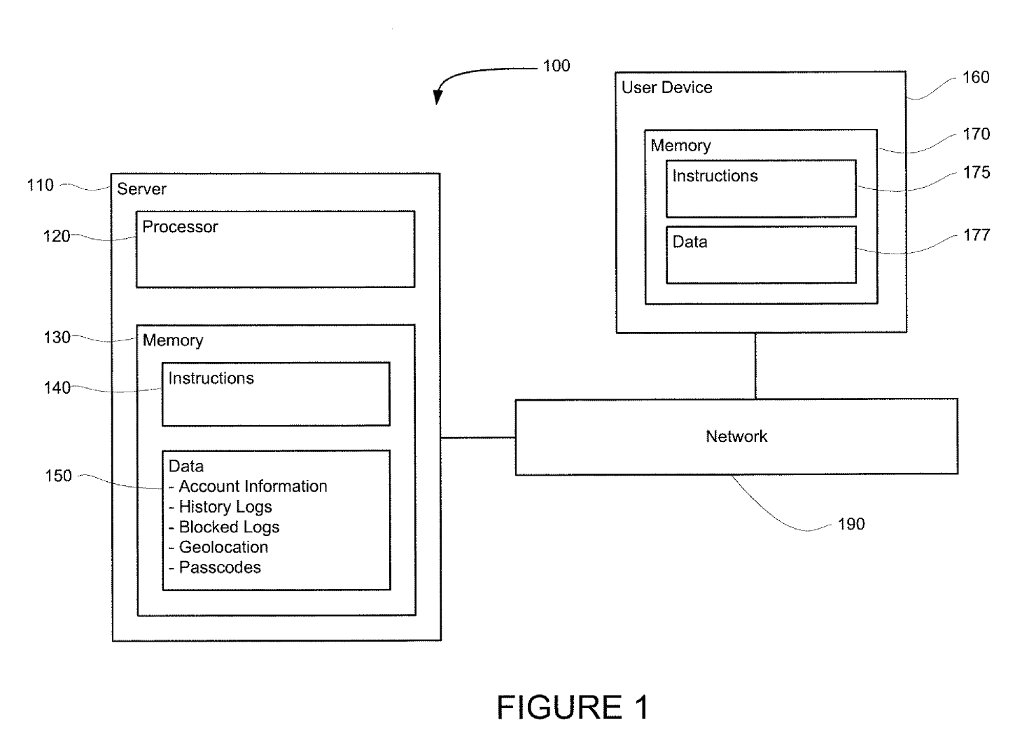

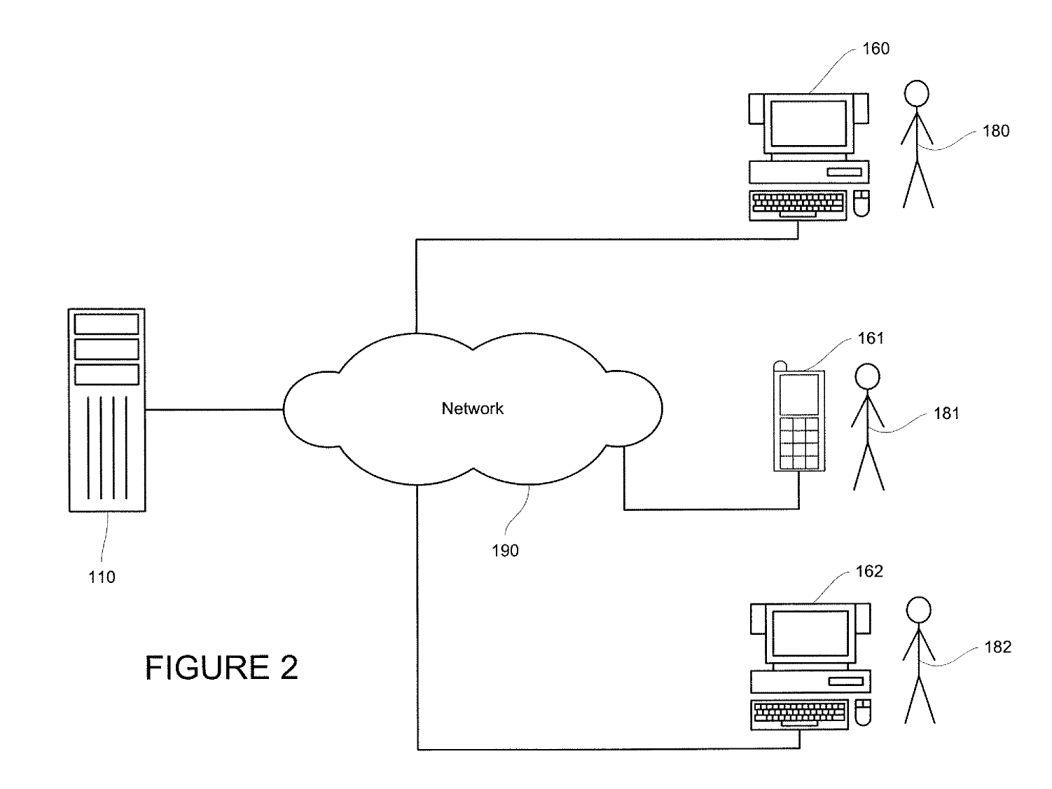

As shown in FIGS. 1-2, a system 100 in accordance with one aspect of the invention includes a computer 110 containing a processor 120, memory 130 and other components typically present in general purpose computers.

Memory 130 stores information accessible by processor 120, including instructions 140 that may be executed by the processor 120. It also includes data 150 that may be retrieved, manipulated or stored by the processor. The memory may be of any type capable of storing information accessible by the processor, including a computer-readable medium such as a hard-drive, memory card, ROM, RAM, DVD, CD-ROM or other optical disks, as well as other write-capable, and read-only memories. The processor 120 may be any well-known processor, such as processors from Intel Corporation or AMD. Alternatively, the processor may be a dedicated controller such as an ASIC.

The instructions 140 may be any set of instructions to be executed directly (such as machine code) or indirectly (such as scripts) by the processor. For example, the instructions may be stored as computer code on the computer-readable medium. In that regard, the terms “instructions,” “steps” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

Data 150 may be retrieved, stored or modified by processor 120 in accordance with the instructions 140. For instance, although the system and method are not limited by any particular data structure, the data may be stored in computer registers, in a relational database as a table having a plurality of different fields and records, XML documents, or flat files. The data may also be formatted in any computer-readable format such as, but not limited to, binary values, ASCII or Unicode. By further way of example only, image data may be stored as bitmaps comprised of pixels that are stored in compressed or uncompressed, or lossless or lossy formats (e.g., JPEG), vector-based formats (e.g., SVG) or computer instructions for drawing graphics. Moreover, the data may comprise any information sufficient to identify the relevant information, such as numbers, descriptive text, proprietary codes, pointers, references to data stored in other memories (including other network locations) or information that is used by a function to calculate the relevant data.

Although FIG. 1 functionally illustrates the processor and memory as being within the same block, it will be understood by those of ordinary skill in the art that the processor and memory may actually comprise multiple processors and memories that may or may not be stored within the same physical housing. For example, some of the instructions and data may be stored on removable CD-ROM and others within a read-only computer chip. Some or all of the instructions and data may be stored in a location physically remote from, yet still accessible by, the processor. Accordingly, references to a processor or computer will be understood to include references to a collection of processors or computers that may or may not operate in parallel.

In one aspect, computer 110 is a server communicating with one or more client computers 160-62 (only client 160 being shown in FIG. 1 for clarity). For example, computer 110 may be a web server. Each client computer may be configured similarly to the server 110, with a processor, memory and instructions. Each client computer 160-620 may be a personal computer, intended for use by a person 180-82, having all the internal components normally found in a personal computer such as a central processing unit (CPU), display device (for example, a monitor having a screen, a projector, a touch-screen, a small LCD screen, a television, or another device such as an electrical device that is operable to display information processed by the processor), a computer-readable medium (for example, a CD-ROM, hard-drive, RAM or ROM), user input (for example, a mouse, keyboard, touch-screen or microphone), speakers, modem and/or network interface device (telephone, cable or otherwise) and all of the components used for connecting these elements to one another. Moreover, computers in accordance with the systems and methods described herein may comprise any device capable of processing instructions and transmitting data to and from humans and other computers including general purpose computers, PDAs, network computers lacking local storage capability, and set-top boxes for televisions.

Although the client computers 160-162 may comprise a full-sized personal computer, the system and method may also be used in connection with mobile devices capable of wirelessly exchanging data with a server over a network such as the Internet. For example, client computer 161 may be a wireless-enabled PDA such as a Blackberry phone or an Internet-capable cellular phone. In either regard, the user may input information using a small keyboard (in the case of a Blackberry phone), a keypad (in the case of a typical cell phone), a touch screen (in the case of a PDA) or any other means of user input.

The server 110 and client computers 160-62 are capable of direct and indirect communication, such as over a network 190. Although only a few computers are depicted in FIGS. 1-2, it should be appreciated that a typical system can include a large number of connected computers, with each different computer being at a different node of the network 190. The network, and intervening nodes, may comprise various configurations and protocols including the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computers, such as modems (e.g., dial-up, cable or fiber optic) and wireless interfaces.

Although certain advantages are obtained when information is transmitted or received as noted above, other aspects of the system and method are not limited to any particular manner of transmission of information. For example, in some aspects, information may be sent via a medium such as a disk, tape or CD-ROM. In other aspects, the information may be transmitted in a non-electronic format and manually entered into the system. Yet further, although some functions are indicated as taking place on a server and others on a client, various aspects of the system and method may be implemented by a single computer having a single processor.

Data 150 of server 110 may store information relating to users. This information may include, for example, usernames and passwords and other account information. Preferably, passwords are encrypted or otherwise stored in a secure manner. As explained in more detail below, data 150 may include an account history log for recording information relating to logins such as address of the network node used to log in, the date and time, and the total access time for each login. Data 150 of server 110 may also include information regarding blocked locations and override pass codes.

Data 150 may also include geolocation information 150 to be used by server 110 to approximate geographic locations. As described in more detail below, using instructions 140, server 110 may access the geolocation information 150 and extrapolate geographic locations from network addresses. Geolocation locations may be expressed in various ways and specificity including but not limited to latitude/longitude positions, street addresses, towns, states, countries and ranges of the foregoing.

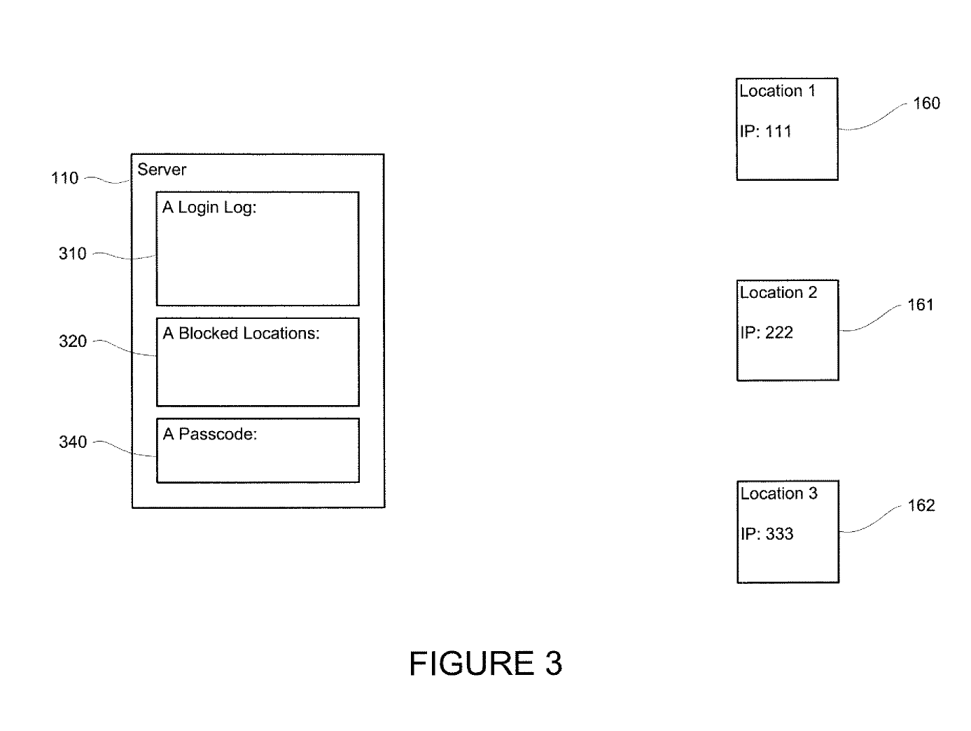

As will be described in more detail below, each node on the network may be associated with both a network address and a physical address. For example, each device may be assigned an IP address. An IP address may be expressed as binary numbers or various combinations of numbers, letters, or both. For example, client computers 160-62 of FIG. 3 are each identified by an IP address, such as IP 111, 222, and 333 respectively, it being understood that the IP addresses are typically 32-bits or 64-bit integers and may be displayed in various ways, for example 3479374081 or 207.99.9.1. Client computers 160-162 are also associated with a physical location, such as Locations 1-3 respectively.

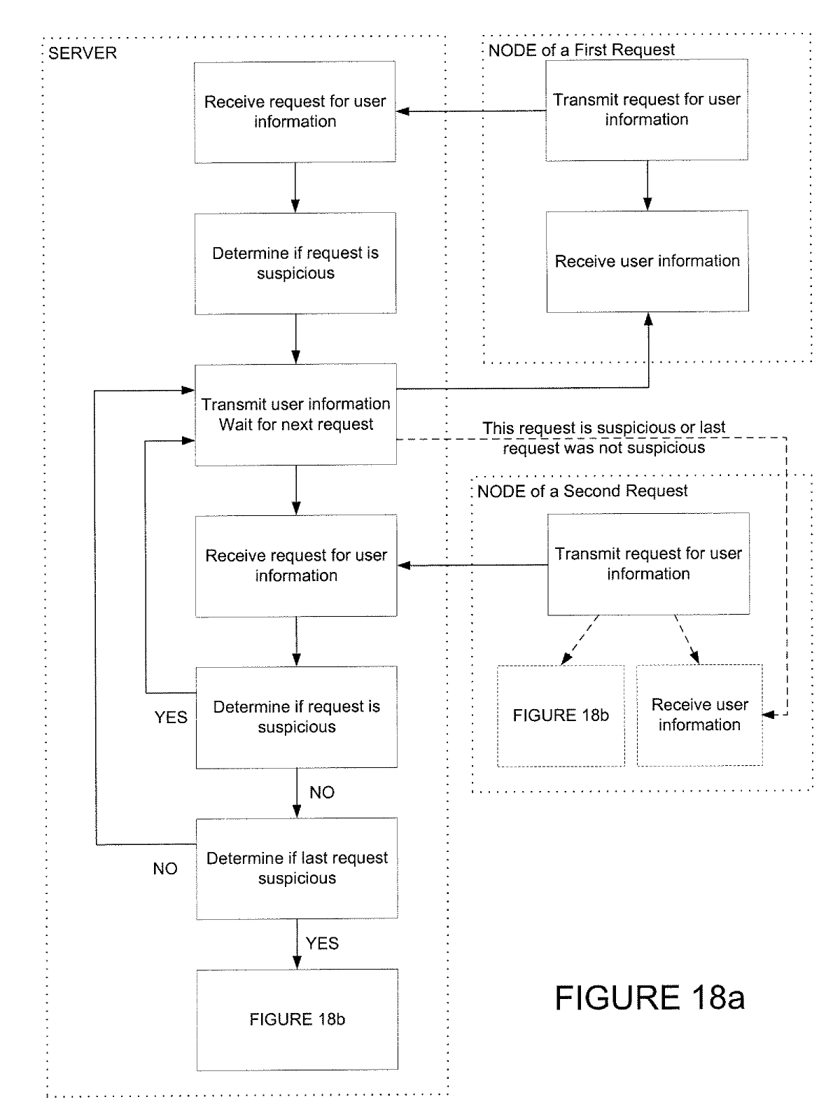

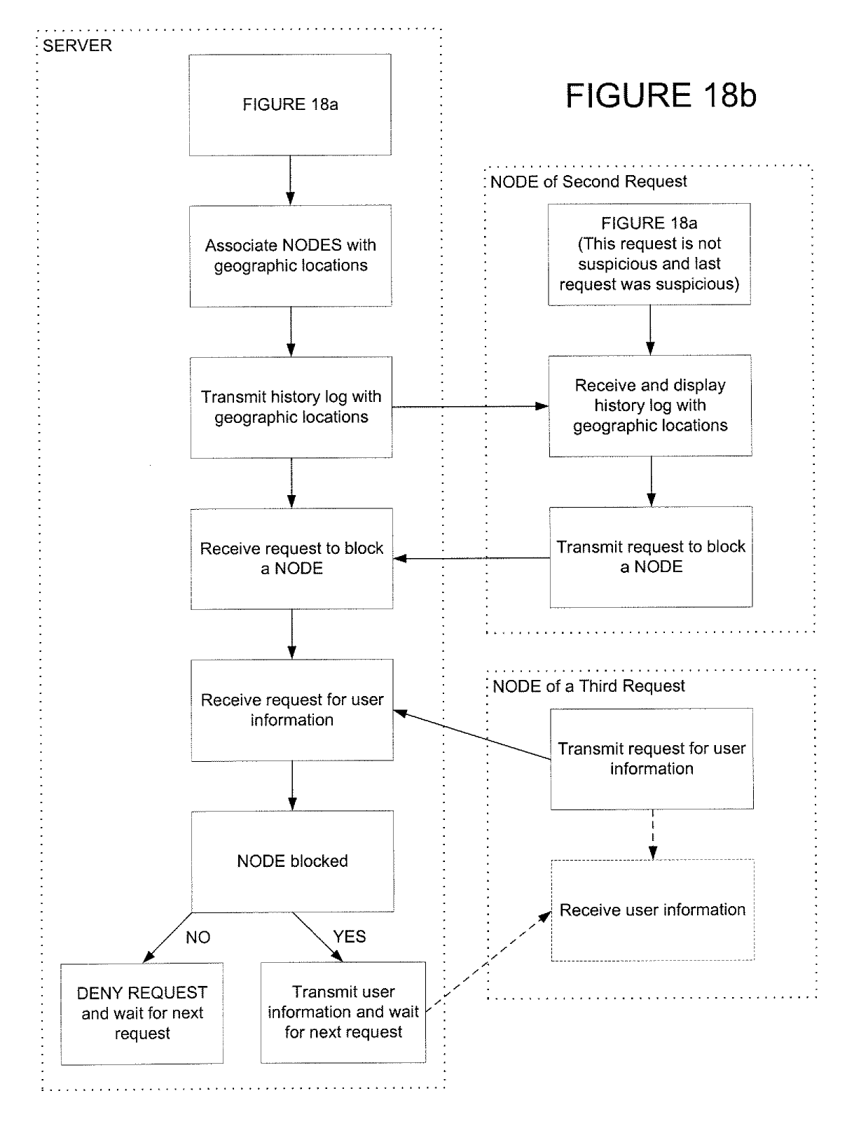

In addition to the operations illustrated in FIGS. 18a and 18b, various operations in accordance with a variety of aspects of the invention will now be described. It should be understood that the following operations do not have to be performed in the precise order described below. Rather, various steps can be handled in reverse order or simultaneously.

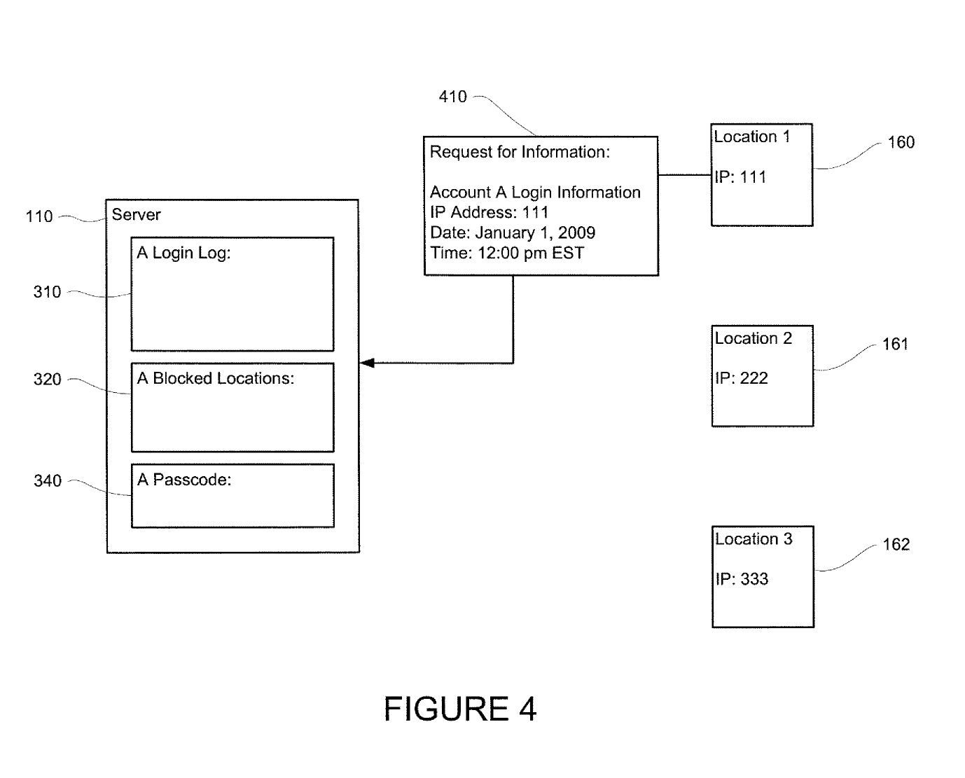

Devices on the network may send requests for information to server 110. For example, as shown in FIG. 4, client computer 160 sends a request for information 410 to server 110. In the example, the request for information is a request to login to email account A (such as www.gmail.com). When the request 410 is received by server 110, the server identifies the IP address of client computer 160 as well as date and time information.

Server 110 reviews the request for information and determines if the request is suspicious. The server 110 may determine if a request is suspicious through various methods.

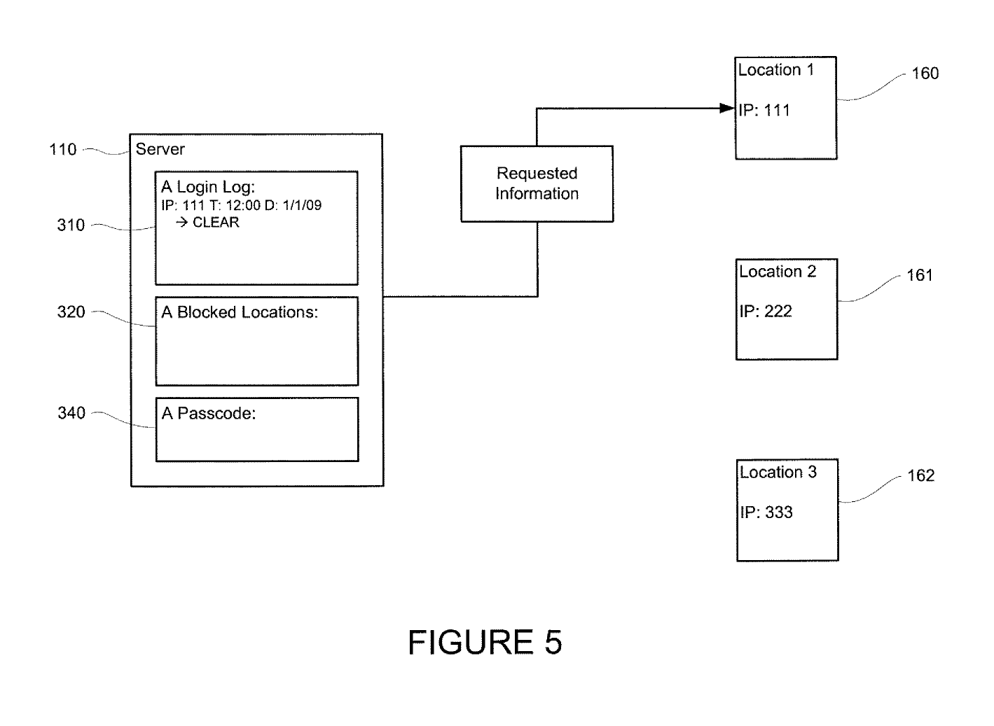

In one aspect, the server 110 may determine that a request is suspicious by accessing or estimating the geographic location of the last node that was used to log in, and comparing it with the current login node. The geographic location of a node may be estimated by accessing a geolocation service. For example, if the server determines that it would be difficult or impossible for a person to travel from the last geographic location to the current geographic location in the span of time between logins (e.g., the last login was from California three hours ago and the current login is from New York, or the last login was from California six hours ago and the current login is from London), the login may be considered suspicious. In another example, server 110 may determine that a login is suspicious if the same IP address has been used to access many accounts which may be suspicious or hijacked.

Where the request is not suspicious, the server records the login information and sends the client computer the requested information. For example and as shown in FIG. 5, server 110 will record in A Login Log 310 the IP address of client computer 160 as well as the date and time of the login. Once server 110 has determined that the request is not suspicious, it may send the requested information to client computer 160.

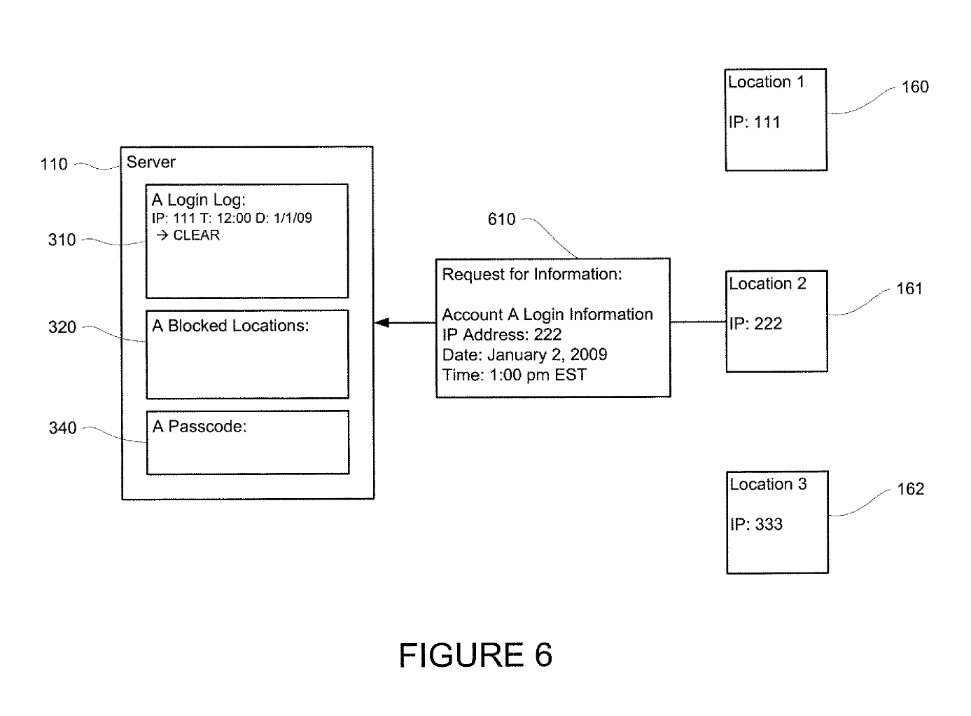

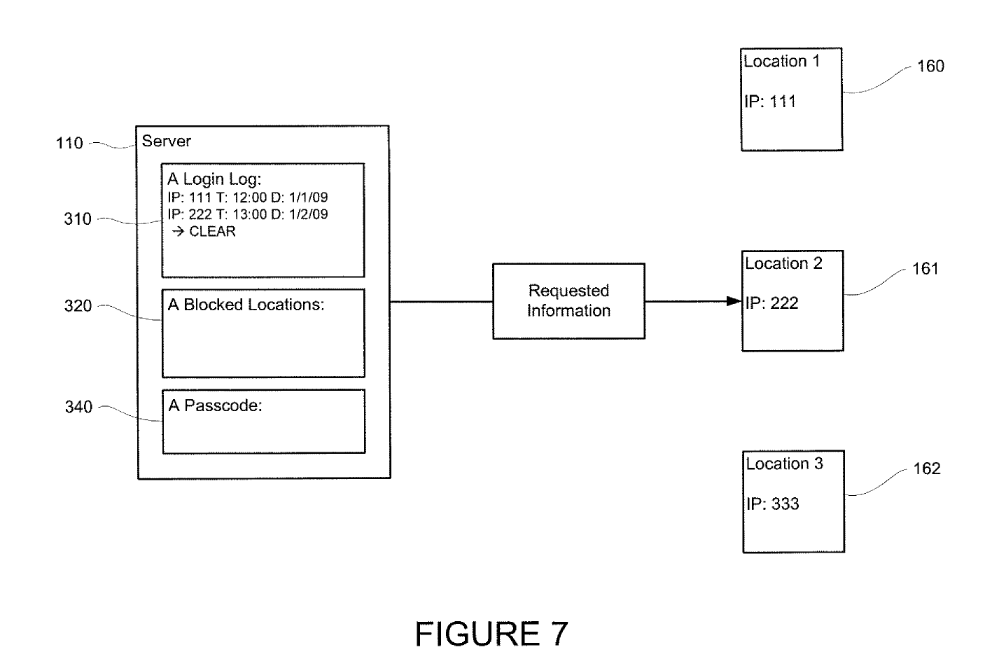

Server 110 will continue to allow access to the requested information if the request is not suspicious. For example, FIG. 6 shows an additional login attempt to Account A from a different client computer. Server 110 determines the IP address and login date and time, and records the information as shown in FIG. 7. Again, server 110 determines that the request is not suspicious and sends the requested information.

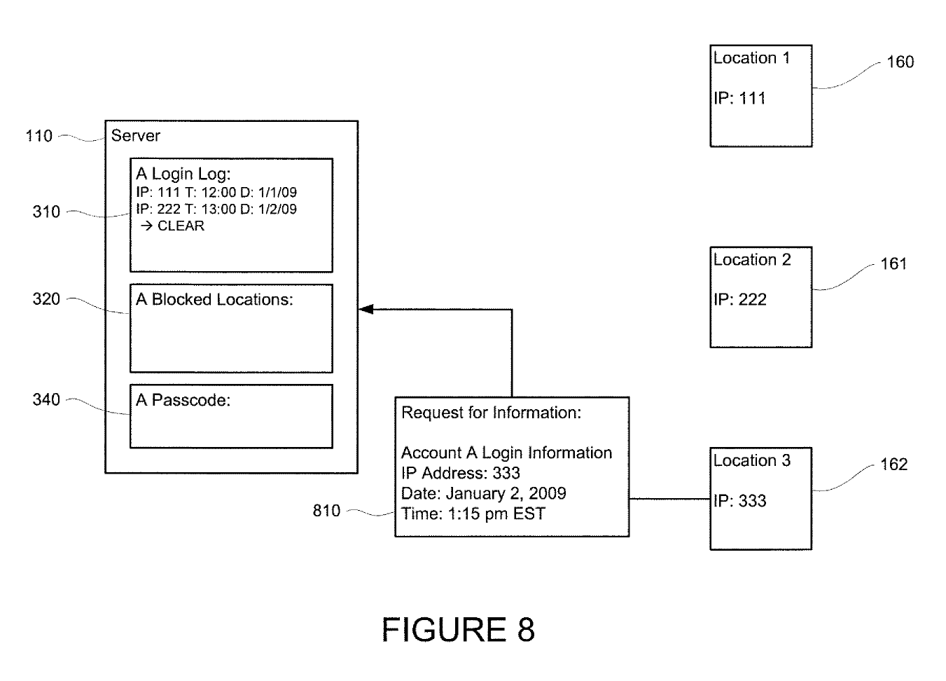

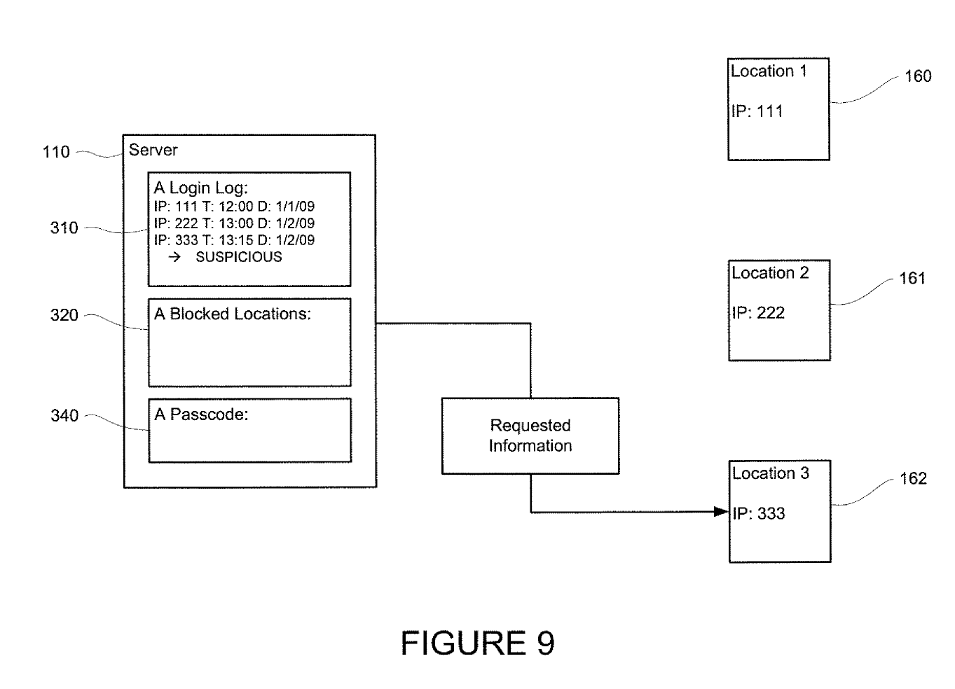

Server 110 may identify and record suspicious login. For example, as shown in FIG. 8, client computer 162 with IP address 333 sends a request for information 810 to server 110. As shown in FIG. 9, Server 110 identifies the request as suspicious. For example, Location 2, associated with IP address 222, may be a location in Pennsylvania and Location 3, associated with IP address 333, may be a location in Alaska. In the example, computer 161 may send a request to access account A from Pennsylvania at 1:00 PM Eastern Standard Time. Thirty minutes later, client computer 162 may send a request to access the same account from Alaska. Server 110 may recognize that the two requests from different geographic locations are within too short a period of time, such as hours, minutes, or even seconds. Accordingly, server 110 will identify client computer 161's request as suspicious and log the IP address, date, and time of the login attempt. Moreover, the server may refuse to send the requested information in response to any suspicious login.

In some circumstances, the current request may have some characteristics of being unauthorized by the legitimate user, but not be clearly illegitimate. For example, the distance in time and geographic locations of two consecutive logins may be suspicious but not impossible. In that regard and as shown in FIG. 9, the requested information may be sent and the login logged as suspicious. By further way of example, the server may subsequently determine that it was the prior login that was suspicious rather than the current login (such as the previous login being from a country other than the United States when every other login, including the current request, was from a node based in the United States).

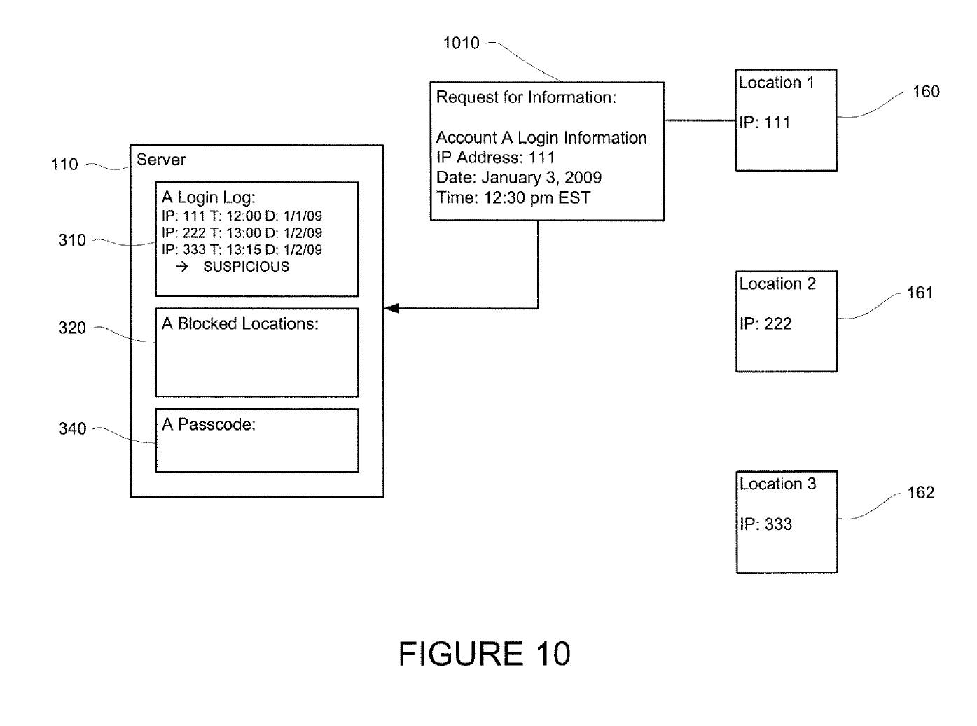

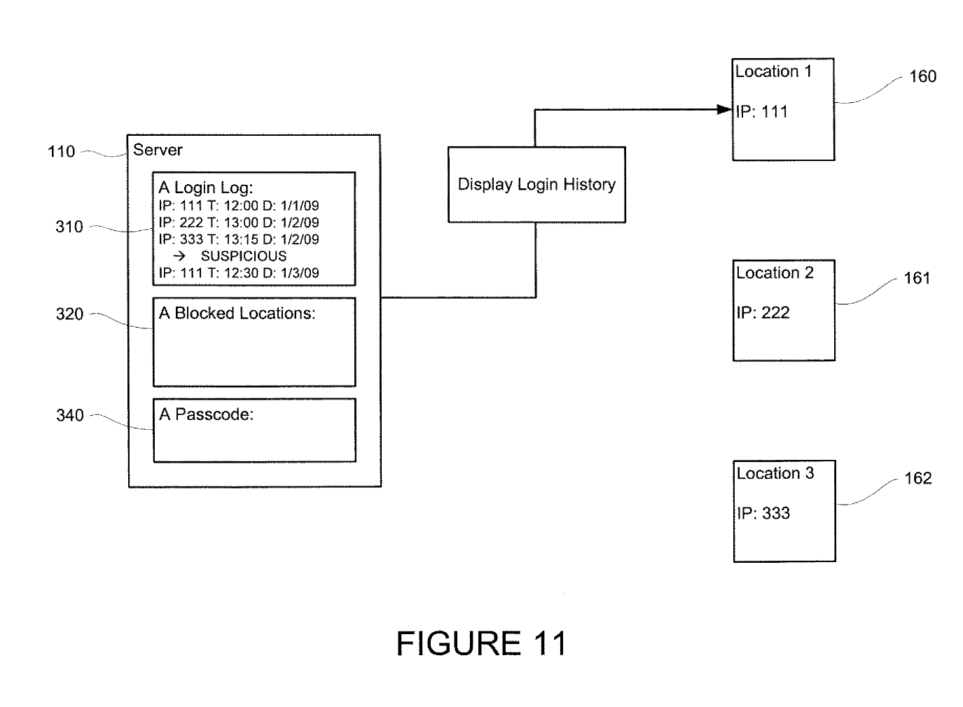

Upon the next login attempt not determined to be suspicious, the server 110 may send to the requesting client computer a list of the geographic locations and access time associated with the suspicious logins. For example, as shown in FIG. 10, client computer 160 requests information regarding account A from server 110. As shown in FIG. 11, the server 110 determines that the request 1100 is not suspicious, but that the last login to account A was suspicious. Server 110 sends client device 160 a history log.

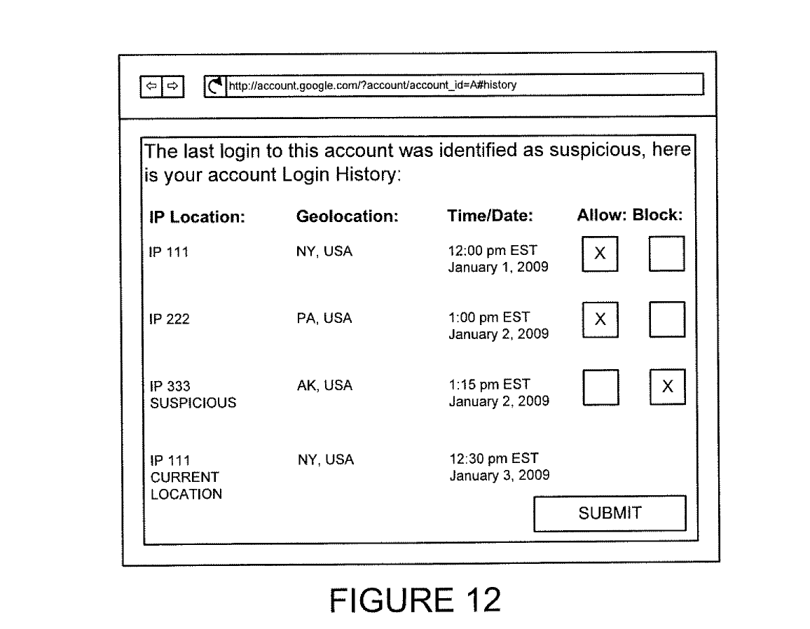

FIG. 12 is an example screen shot depicting a history log. The log may include the IP location, associated geographic location, date, and time for each request for information. In the example, the screen shot notifies the user that the last login was suspicious, identifies the suspicious login, and also identifies the location associated with the present login, request 1010.

A user may restrict access to the account based on geographic location or the identity of the node. For example, the history log may also include an option to block access to information based on the location. For example, the user may restrict access to a particular IP address. As shown in FIG. 12, user 161 has chosen to block IP 333 associated with Alaska. The history log may also include an option to allow access to information based on the location. User 161 has also chosen to allow IP addresses 111 and 222 associated with New York and Pennsylvania, respectively. However, the user need not make any specific choices with regard to any address.

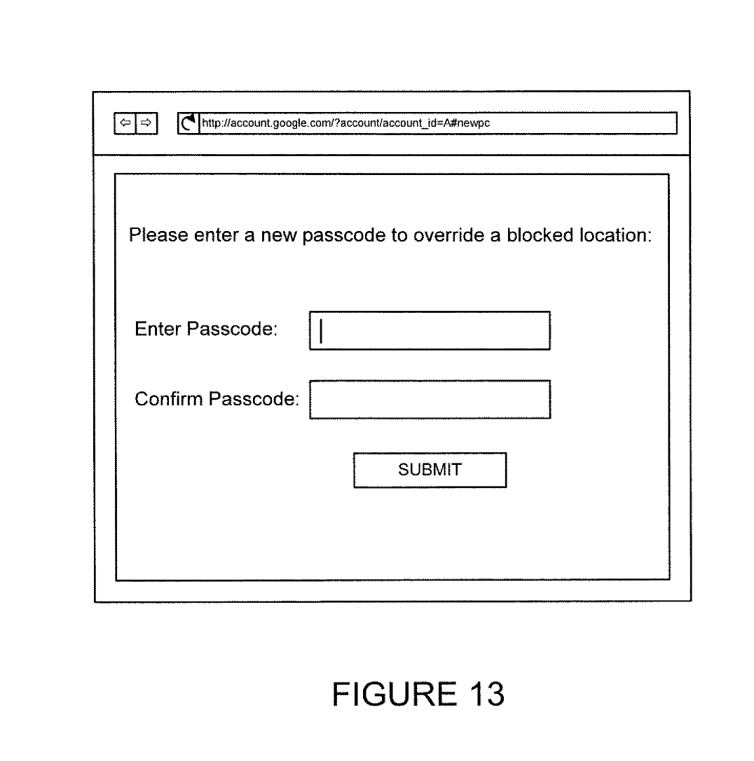

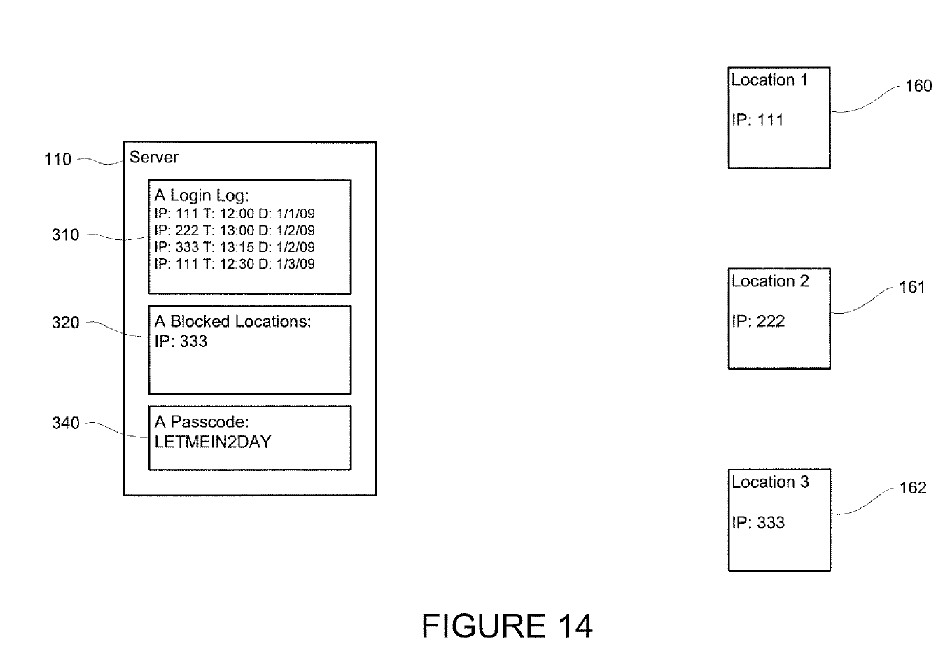

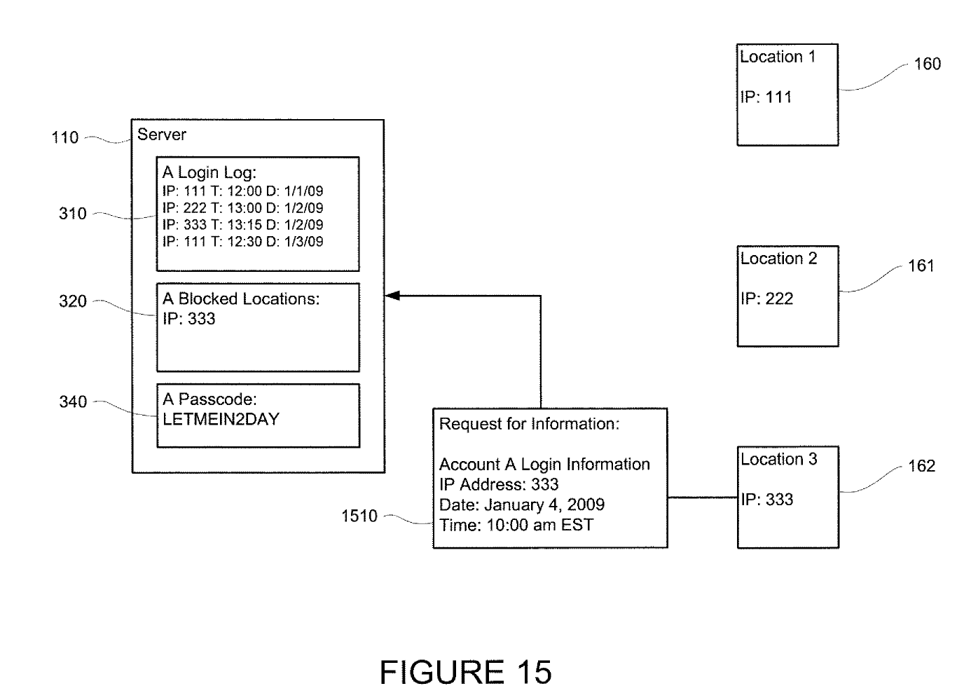

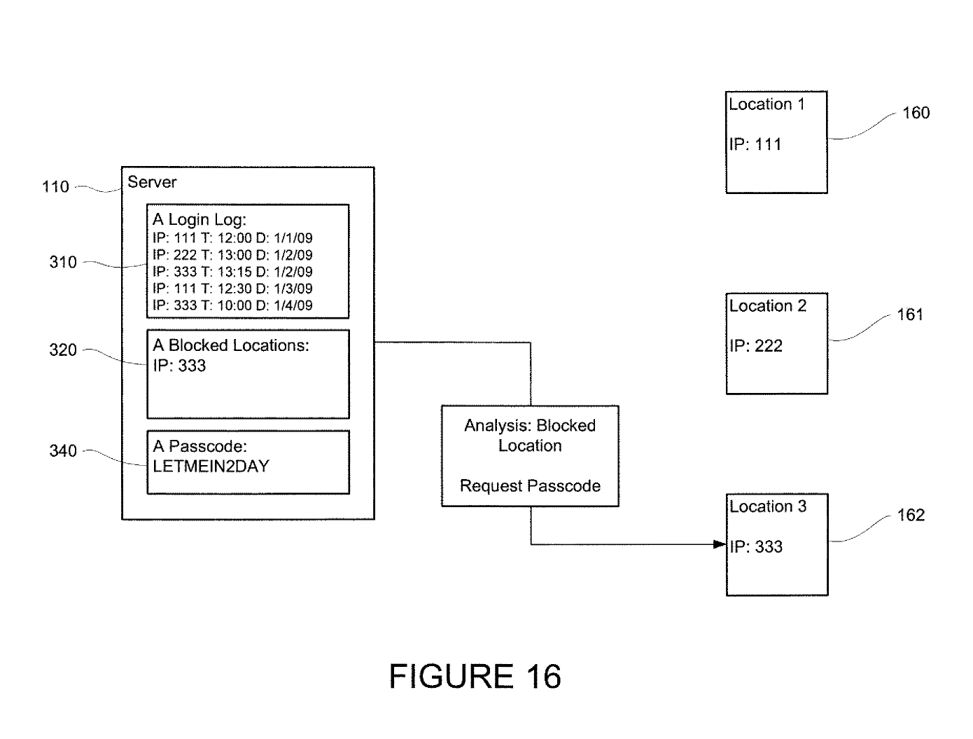

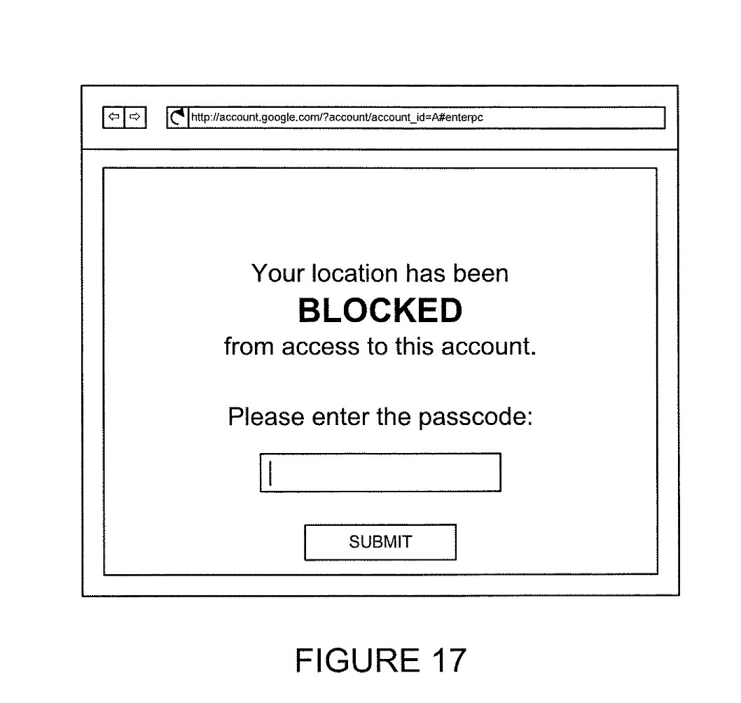

The system may also allow the user to choose a passcode. The passcode, which may be different from a user's account login password, can be used to override a block on a location. In one example, the user may be prompted to choose and enter a new passcode, as shown in FIG. 13. Server 110 may store this information, as shown in FIG. 14. In the example, the account A passcode is shown as “LETMEIN2DAY,” but may be any combination of letters, numbers, symbols or other devices.

Where a passcode has been stored, a user may use the passcode to override a blocked location. For example, in FIG. 15, a request for information 1510 is sent from client device 162 at IP 333. Server 110 determines from the IP address that the client device 162 is listed as a blocked location. Server 110 sends a request for the passcode as shown in FIG. 16. The client device 162 may display the request as shown in FIG. 17. If the passcode is not entered correctly, the server will not send the requested information to the client device. However, if the passcode is entered correctly, the server 110 will override the block on the IP address and send the requested information.

One of the advantages of the system and method is its ability to accommodate a number of alternatives.

Although FIG. 12 displays both the geographic and IP locations of each login, the user may be provided with the option to hide from viewing the geographic location or IP location of the entries. For example, a more sophisticated user may be interested in the IP address of a login, whereas a less sophisticated user may be confused by this information and choose to hide it from view.

The examples of FIGS. 12, 13 and 17 depict screen shots, however information sent to the user may be displayed in a variety of ways. For example, the information may be contained within a pop-up, information bar, or other means of display.

The server may block or allow requests from various locations based on the IP address or geographic area. For example, referring to FIG. 12, the user has allowed access to IP 111. Server 110 may then allow requests from IP 111 and not regard such requests as suspicious. Alternatively, server 110 may also allow and not regard as suspicious requests from all IP addresses associated with a geographic location within or near New York, U.S.A. For example, server 110 may allow requests from an entire city, county, country or other geographic division. This may also be true where locations are blocked. For example, if the user chooses to block requests from IP 333, the server may block all requests for information from that particular IP address. Alternatively, server 110 may block all IP addresses associated with a geographic location within or near Alaska, U.S.A. For example, server 110 may block requests from an entire city, county, country or other geographic division.

Passcode information may be determined during the initial request for information. For example, upon the initial set up of an online account, server 110 may request the user to input a passcode. Server 110 may therefore display the image of FIG. 13 before any suspicious request for information has been made with respect to the account. Upon receipt of a suspicious request for information, server 110 may automatically send a request for a passcode rather than sending the requested information.

In yet another aspect, the user may provide the server 110 with a safe location to send a text message using, for example, short messaging service or SMS. Where a request originates from a blocked location, the user may be prompted to request a text message and send the message to the server to override the block. The server may determine or retrieve a text message previously associated with the online account and send the text message to the safe location. The user may then reply to the text message and override the block.

Most of the foregoing alternative embodiments are not mutually exclusive, but may be implemented in various combinations to achieve unique advantages. As these and other variations and combinations of the features discussed above can be utilized without departing from the invention as defined by the claims, the foregoing description of the embodiments should be taken by way of illustration rather than by way of limitation of the invention as defined by the claims. It will also be understood that the provision of examples of the invention (as well as clauses phrased as “such as,” “including” and the like) should not be interpreted as limiting the invention to the specific examples; rather, the examples are intended to illustrate only one of many possible embodiments.

1. A method of preventing access to user account information on a network, the method comprising:
accessing, by one or more processors of one or more server computers, a history log associated with user account information of a user, the user account information being accessible via a first node on a network, and where the history log identifies a plurality of requests, each of the plurality of requests being received from one of plurality of originating computers of the network that accessed the user account information;
receiving, by the one or more processors, a first request for access to the user account information from a first computer;
providing, by the one or more processors, the first computer with access to the user account information in response to the first request for access to the user account information;
recording, by the one or more processors, characteristics of the first request for access associated with the first computer in the history log;
determining, by the one or more processors, that information of the history log including the characteristics associated with the first computer matches criteria, the criteria including receiving multiple requests for information indicative of access that was not authorized by the user;
receiving, by the one or more processors, after the first request for access a next request from a second computer for access to the user account information;
determining, by the one or more processors, that the next request for access to the user account information does not match the criteria and is an authorized request for access;
upon determining that the next request for access to the user account information that does not meet the criteria and is an authorized request for access, sending, by the one or more processors, to the second computer, to display to the user a notification that a prior attempt to request the user account information was suspicious and the history log including:
a list of the plurality of originating computers,
a geographic location for each of a plurality of the originating computers identified by the history log, a date and time for each of the plurality of requests, and
an option to prevent future access to the account by any of the plurality of originating computers;
receiving, by the one or more processors, in response to the sending, user input selecting the option for a given computer of the plurality of originating computers to prevent future access to the account information by the given computer, the given computer being the first computer;
after receiving the data, identifying, by the one or more processors, the given computer, receiving a request to access the user account information from the given computer; and
after receiving the request to access the user account information from the given computer, preventing, by the one or more processors, the user account information from being accessed by the given computer based on the received data.

2. The method of claim 1 wherein the geographic location is represented by the name of a state and a country.

3. The method of claim 1 wherein the data identifying one of the computers of the history log includes an IP address of the given computer.

4. The method of claim 1, further comprising receiving a passcode, wherein the passcode allows access to the user account information by the given computer.

5. The method of claim 2, further comprising sending a request for a passcode to the given computer.

6. The method of claim 1, wherein the criteria further includes receiving multiple requests for different users' information from a single computer.

7. The method of claim 1, wherein each of the plurality of originating computers on the network are associated with a geographic location.

8. The method of claim 7, further comprising preventing the user account information from being accessed by any of the plurality of originating computers associated with a geographic location which is also associated with the given computer.

9. A system comprising:
a memory storing instructions and a history log including a list of requests for the information, an originating computer of a plurality of originating computers from which each request of the list of requests was received, a geographic location for each of the plurality of requests, a date and time for each of the plurality of requests;
one or more processors in communication with the memory so as to process information in accordance with the instructions; and;
the instructions comprising:
in response to a first request for access to the user account information from a first computer, providing the first computer with access to the user account information in response to the first request for access to the user account information;
recording characteristics of the first request for access associated with the first computer in the history log;
determining that information of the history log including the characteristics associated with the first computer indicates that the first request for access was suspicious;
receiving after the first request for access a next request from a second computer for access to the user account information;
determining that the next request for access is an authorized request for access;
upon determining that the next request for access to the user account information is an authorized request for access
when the next request for access is determined to be an authorized request for access, sending, to another computer on the network, for display to a user a notification that a prior attempt to request the user account information was suspicious, the history log, and an option to prevent future access to the account by any of the plurality of originating computers;
receiving, in response to the sending, user input selecting the option for a given computer of the plurality of originating computers of the history log to prevent future access to the account information by the given computer, the given computer being the first computer;
after receiving the data identifying the given computer of the history log, receiving a request to access the user account information from the given computer; and
after receiving the request to access the user account information from the given computer, preventing the user account information from being accessed by the given computer based on the received data.

10. The system of claim 9, wherein the instructions further comprise transmitting a geographic location instruction only where a request for information is determined to be suspicious.

11. The system of claim 9, wherein the instructions further comprise receiving a passcode, wherein the passcode allows access to the user account information by the given computer.

12. The system of claim 11, wherein the instructions further comprise transmitting a request for a passcode to the given computer in response to receiving the request to access the user account information from the given computer.

13. The system of claim 11, wherein the geographic locations comprise GPS coordinates.

14-20. (canceled)

21. The method of claim 1, wherein determining, with the processor, whether a computer of the plurality of originating computers identified by the history log matches criteria including receiving multiple requests for information indicative of access that was not authorized by the user, further includes determining whether requests for a user's account information from a first computer associated with a first geographic location and a second computer associated with a second geographic location are received within a time period less than a threshold period.

22. The method of claim 21, wherein the method further comprises determining a distance between the first geographic location and the second geographic location and threshold period is based on the distance between the first geographic location and the second geographic location.

23. A non-transitory computer readable medium on which instructions are stored, the instructions when executed by one or more processors cause the one or more processors to perform a method, the method comprising:
in response to a first request for access to the user account information from a first computer, providing the first computer with access to the user account information in response to the first request for access to the user account information;
recording characteristics of the first request for access associated with the first computer in a history log, the history log including a list of requests for the information, an originating computer of a plurality of originating computers from which each request of the list of requests was received, a geographic location for each of the plurality of requests, a date and time for each of the plurality of requests;
determining that information of the history log including the characteristics associated with the first computer indicates that the first request for access was suspicious;
receiving after the first request for access a next request from a second computer for access to the user account information;
determining that the next request for access is an authorized request for access;
when the next request for access to the user account information is determined to be an authorized request for access, sending, to another computer on the network, for display to a user a notification that a prior attempt to request the user account information was suspicious, the history log, and an option to prevent future access to the account by any of the plurality of originating computers;
receiving, in response to the sending, user input selecting the option for a given computer of the plurality of originating computers of the history log to prevent future access to the account information by the given computer, the given computer being the first computer;
after receiving the data identifying the given computer of the history log, receiving a request to access the user account information from the given computer; and
after receiving the request to access the user account information from the given computer, preventing the user account information from being accessed by the given computer based on the received data.

24. The medium of claim 23, wherein the method further comprises transmitting a geographic location instruction only where a request for information is determined to be suspicious.

25. The medium of claim 24, wherein the method further comprises receiving a passcode, wherein the passcode allows access to the user account information by the given computer.

26. The medium of claim 23, wherein the method further comprises transmitting a request for a passcode to the given computer in response to receiving the request to access the user account information from the given computer.

27. The medium of claim 23, wherein the method further comprises determining whether a computer of the plurality of originating computers identified by the history log matches criteria including receiving multiple requests for information indicative of access that was not authorized by the user by determining whether requests for a user's account information from a first computer associated with a first geographic location and a second computer associated with a second geographic location are received within a time period less than a threshold period.

28. The medium of claim 27, wherein the method further comprises determining a distance between the first geographic location and the second geographic location and threshold period is based on the distance between the first geographic location and the second geographic location.
